(19) United States
(12) Patent Application Publication
(10) Pub. No.: US 2007/0209032 A1
(43) Pub. Date: Sep. 6, 2007

(54) Driver verifier

(75) Inventors: Daniel S. Mihai, Snoqualmie, WA (US); Gerald F. Maffeo, Woodinville, WA (US); Silviu C. Calinoiu, Kirlkand, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/360,153

(22) Filed: Feb. 23, 2006

(51) Int. Cl. G06F 9/44

(52) U.S. Cl. 717/126

(57) ABSTRACT

A method for verifying driver component behavior is provided. A driver verification component verifies that a driver component processes I/O requests in a specified amount of time. The driver verification component also verifies that pending I/O requests are processed correctly by a driver component. The driver verification component further verifies that a set of parameters in a call to a driver component conforms with security requirements. Additionally, the driver verification component can be enabled for selected drivers and/or selected checks without rebooting the system.

### BACKGROUND

In contemporary operating systems, low-level components, often referred to as kernel mode components, including drivers and the operating system itself, handle critical system operations. For performance and architectural reasons, drivers typically load in an environment in which a loaded driver can access the resources of another loaded driver. Consequently, kernel mode components, such as drivers, are typically highly privileged in the operations that they are allowed to perform. Because of these privileges, the typical operating system cannot provide the same protection mechanisms as it can for higher level components, such as software applications. As a result, even the slightest error in kernel components can corrupt the operating environment and cause a computer system crash.

Determining the cause of a computer system crash so that an appropriate fix may be made can be a difficult, labor-intensive and somewhat unpredictable task, particularly since it is often difficult to replicate the exact conditions under which an error occurred. Additionally, pre-emptive testing of driver functionality in specific scenarios can be difficult for infrequently accessed events. For example, if a thread that previously issued an I/O request exits before the request is completed, a cancel routine associated with the request can be called to clean up resources associated with the previously pending request. Because cancellation of a request is an event that happens infrequently, execution of the cancellation routine may not be thoroughly tested in a typical driver testing environment. Another common error condition can occur when drivers fail to pend requests that can take a long or indefinite amount of time. Failure to appropriately pend requests can result in resources related to the request being released before the request has completed. Premature release of resources related to a request can cause data corruption and result in a system crash.

Another type of error condition occurs when a driver component incorrectly accesses data structures associated with pending I/O requests. For example, when a first driver component transmits an I/O request to a second driver component, the first driver component must correctly handle the case where the second driver returns a “status pending” notification. If the first driver does receive status pending in return, then the first driver must ensure that data structures referenced by the request are not freed until the request completes. Further, after the request completes, the first driver must not reference any fields associated with the request because the request might have previously been freed, and thus the driver would be accessing bad data. This error condition is also difficult to test because a tester of the first driver may not be able to control whether the second driver returns a pending status in response to I/O requests.

Yet another type of error condition occurs when user mode handles are referenced with kernel mode privileges. User mode handles, as non-privileged handles, should be restricted to referencing only objects to which the current user has been granted security access. This restriction facilitates security checks. However, if a user mode handle is referenced as kernel mode by a driver, then the normal security checks that would be applied to the handle are forgone. In such a case, the currently running application can access an object referenced by the handle even when executed by a user in a security context that normally would not allow the user access to the referenced object. Further, the unprivileged process can modify the user handle such that it will reference a second object which is different from the original object referenced by the same handle value. This can cause the privileged kernel code to access the second object even though the handle was intended to access the original object.

Another type of error occurs when unprivileged user mode memory addresses cross the kernel mode security boundary. Accessing user mode memory from kernel mode code can be a security risk because the unprivileged user mode application can free the memory being accessed, change its memory protection, or change the contents of that memory while the kernel mode code is accessing it. There are specific guidelines that all code running in kernel mode at the boundary of the user mode should follow to guard the system from a possible attack or errors propagated from user mode. However, once the boundary of trust has been crossed the kernel mode code is allowed to assume that all the memory addresses it receives from its callers are kernel mode addresses that are fully trusted. Thus, a security risk is created when the user-kernel mode boundary code allows any of the untrusted user memory addresses to cross the boundary of trust. This can result in various types of data corruption, system crashes, or typical security vulnerabilities, such as elevation of privilege, information disclosure, tampering of data or denial of service.

In addition to being deficient in testing error conditions, driver verification tools typically require a system restart when additional drivers are to be tested and/or when the set of checks is modified.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with an aspect of the invention, a method for verifying driver component behavior is provided. The method can be implemented by a driver verification component. In accordance with the method, the driver verification component verifies that a driver component processes I/O requests in a specified amount of time. I/O requests which do not complete immediately are generally classified as “pending.” The driver verification component verifies that pending I/O requests are processed correctly by a driver component. Further, the driver verification component verifies that a set of parameters in a call to a driver component conforms with security requirements.

In accordance with another aspect of the invention, a computer-readable medium having computer-executable modules for verifying driver components is provided. The computer executable modules include a verification test module for determining whether a driver component processes I/O requests in a specified amount of time. Further, the computer executable modules include a verification test module for determining whether pending I/O requests are processed correctly by a driver component. Still further, the computer executable modules include a verification test module for determining whether a set of parameters in a call to a driver component conforms with security requirements.

In accordance with a further aspect of the invention, a method for enabling a driver verification component is provided. A first initialization of the driver verification component is performed. The first initialization includes initialization of data structures associated with the driver verification component. A request to fully enable the driver verification component is obtained. A second initialization of the driver verification component is performed. The second initialization fully enables the driver verification component for selected driver components. Additionally, the settings associated with the driver verification component can be modified.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a computer system illustrating interactions among components of the system in accordance with an aspect of the present invention;

FIG. 2 is a flow diagram illustrating verification routines implemented by a driver verification component in accordance with an aspect of the present invention;

FIG. 3 is a flow diagram illustrating a hang-verification sub-routine implemented by a driver verification component in accordance with an aspect of the present invention;

FIG. 4 is a flow diagram illustrating a completion/cancellation test sub-routine implemented by a driver verification component in accordance with an aspect of the present invention;

FIG. 5 is a flow diagram illustrating a cancellation-test sub-routine implemented by a driver verification component in accordance with an aspect of the present invention;

FIG. 6 is a flow diagram illustrating a pending verification sub-routine implemented by a driver verification component in accordance with an aspect of the present invention;

FIG. 7 is a flow diagram illustrating a handle-verification sub-routine implemented by a driver verification component in accordance with an aspect of the present invention;

FIG. 8 is a flow diagram illustrating an address-verification sub-routine implemented by a driver verification component in accordance with an aspect of the present invention;

FIG. 9 is a flow diagram illustrating a driver verification update routine implemented by a verification component in accordance with an aspect of the present invention;

FIG. 10 is a flow diagram illustrating a change-settings sub-routine implemented by a driver verification component in accordance with an aspect the present invention; and

FIG. 11 is a block diagram of the system of FIG. 1 illustrating hooking of Kernel function calls by driver verification functions in accordance with an aspect of the present invention.

### DETAILED DESCRIPTION

Generally described, the present invention is directed toward systems and methods for verifying the behavior of user-specified kernel mode components, commonly referred to as drivers. More specifically, in accordance with the present invention, a driver verification component monitors driver processing of requests and ensures that various parameters in a call to a driver component conform with security requirements. Additionally, in another aspect, the driver verification component may be fully initialized when a request to modify the settings of the driver verification component is received. Although the present invention will be described with relation to illustrative verification methods, one skilled in the relevant art will appreciate that the disclosed embodiments are illustrative in nature and should not be construed as limiting.

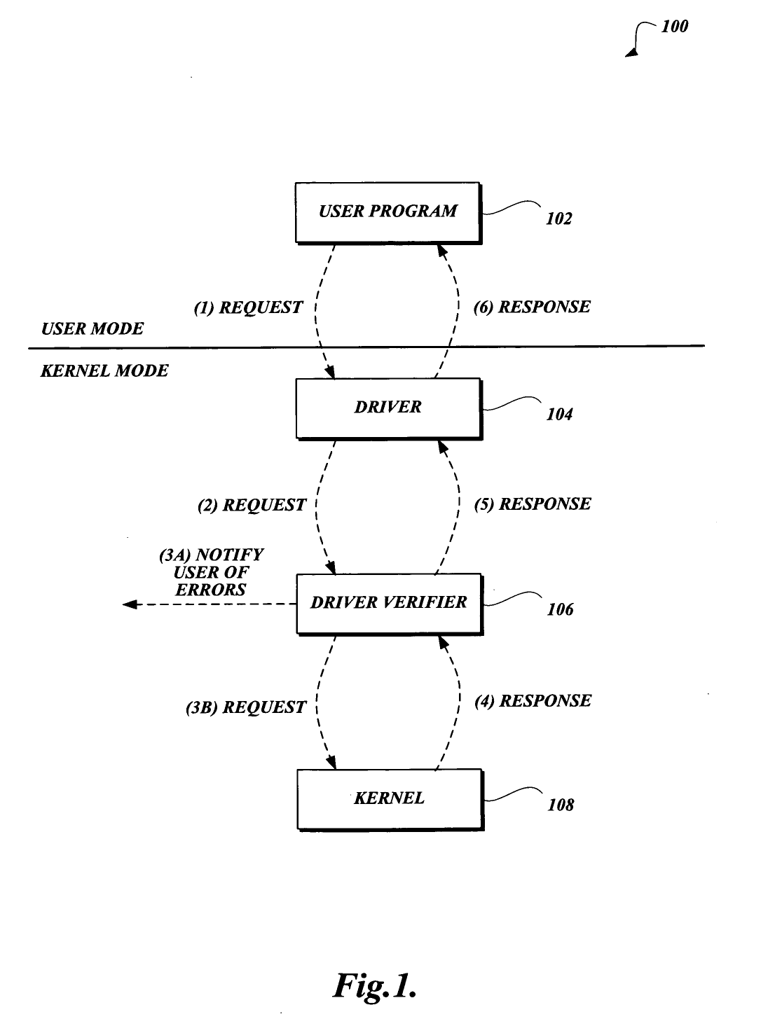

With reference now to FIG. 1, an exemplary computer system 100 includes a user program component 102, a driver component 104, a driver verification component 106, and a kernel component 108. In an illustrative embodiment, the user program component 102 operates in user mode, a nonprivileged mode in which applications typically run, and is operable to transmit a request to a driver component 104. Typically, a user program component 102 that runs in user mode has access to a limited set of interfaces and limited access to computer system data. If the driver component 104 is selected for verification, a request transmitted from the driver component 104 can be redirected such that it is received by a driver verification component 106. In an illustrative embodiment, the driver verification component 106 can notify a user of error conditions. Notification of an error may occur through initiation of a bug check, by logging the error, or through other techniques well-known in the art. In an illustrative embodiment, the driver verificafion component 106 can transmit a request to a kernel component 108. The kernel component 108 can process the request and transmit a response to the driver verification component 106. In an illustrative embodiment, the driver verification component 106 is further operable to transmit a response to the driver component 104 and/or to a user program component 102. The driver component 104, driver verification component 106, and kernel component 108 can operate in kernel mode. Kernel mode is a privileged mode of code execution in which all memory is accessible and all instructions can be issued.

In an alternative embodiment, a driver component 104 can transmit a request directly to the kernel component 108. Further, the kernel component 108 can transmit a request to an object manager, which in turn transmits a request to the driver verification component 106. It will be appreciated by those skilled in the art that the path by which a request travels to the driver verification component 106, and by which a response travels from the driver verification component 106, is not limiting. Further, requests may originate with the driver component 104 and need not be obtained from a user program component 102.

In an illustrative embodiment, a user program component 102 can be a word-processing program, a spreadsheet program, a media player, a web browser, a program that allows a user to manipulate files, or any other type of program that operates in user mode. Additionally, one skilled in the art will appreciate that a driver component 104 may be a disk driver, a keyboard driver, a mouse driver, a network adapter driver, a filter driver, or any other type of driver. Further, one skilled in the art will appreciate that the kernel component 108 is generally the portion of an operating system which manages memory and files and allocates system resources. Additionally, one skilled in the art will appreciate that a request may be a request to perform an I/O operation or any other type of request.

The computer system 100 can include a variety of computer-readable media. Computer-readable media can be any available media that can be accessed by the computer system 100 and includes both volatile and non-volatile media, removable and non-removable media. By way of example, and not limitation, computer-readable media may comprise computer storage media and communication media. Computer storage media includes, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which can be used to store the desired information and which can be accessed by the computer system 100.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner to encode information in the signal. By way of example, and not limitation, communication media includes wired media such as a wired network or direct wired connection, and wireless media such as acoustic, RF, infrared and other wireless media. Combinations of any of the above should also be included within the scope of computer-readable media.

The invention may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

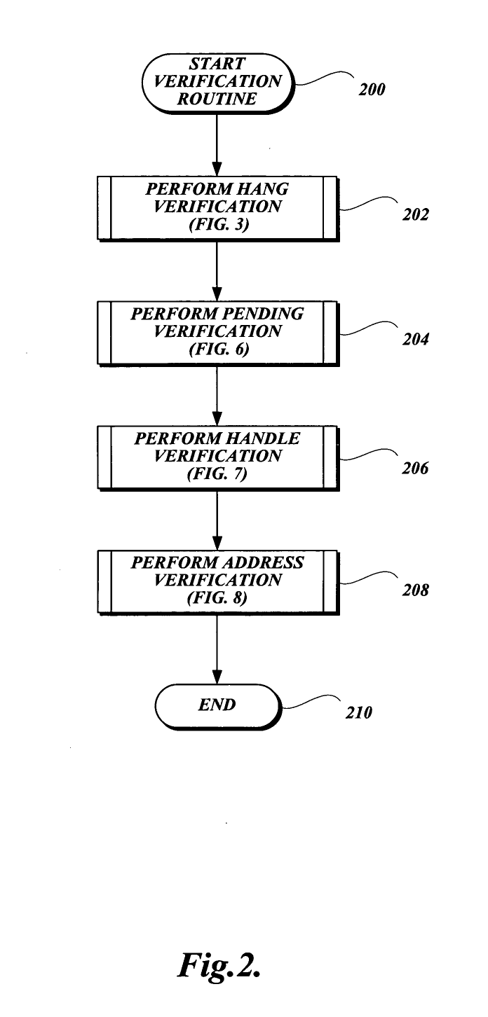

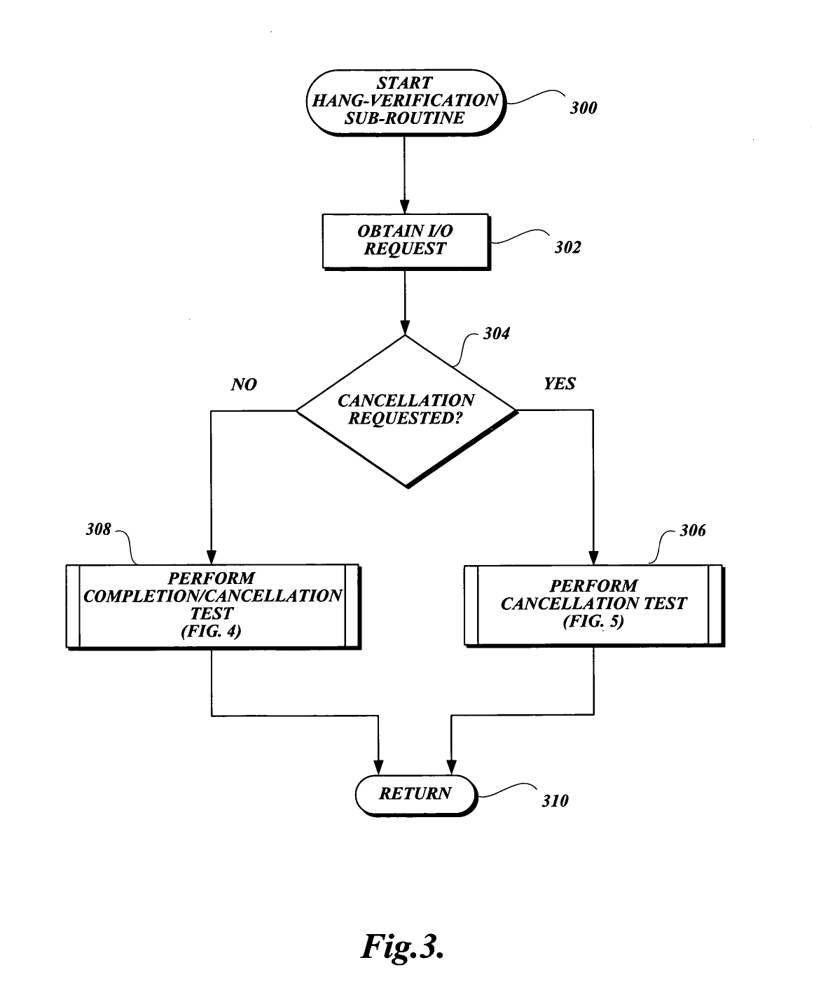

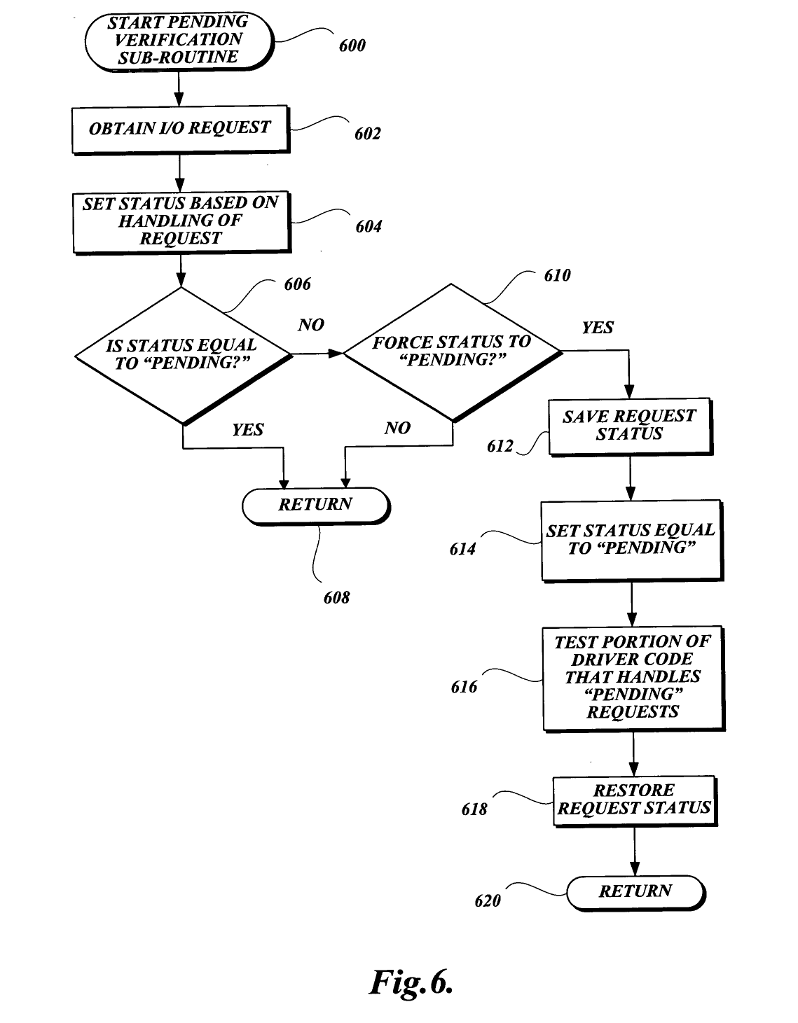

With reference now to FIG. 2, a flow diagram of a driver verification routine 200 implemented by the driver verification component 106 is depicted. At block 202, the driver verification component 106 performs a hang verification sub-routine, which can monitor I/O requests to ensure that the requests are processed in a specified amount of time. Requests that are not processed in a specified amount of time may cause the kernel component 108 to wait for an indefinite period. An exemplary hang verification sub-routine is depicted in FIG. 3 and will be described in greater detail below. At block 204, the driver verification component 106 performs a pending verification sub-routine. Pending verification can ensure that pending requests are handled correctly by driver components. In an illustrative embodiment, a pending state may be entered when the kernel component 108 does not complete a request immediately. An exemplary pending verification sub-routine is depicted in FIG. 6 and will be described in greater detail below.

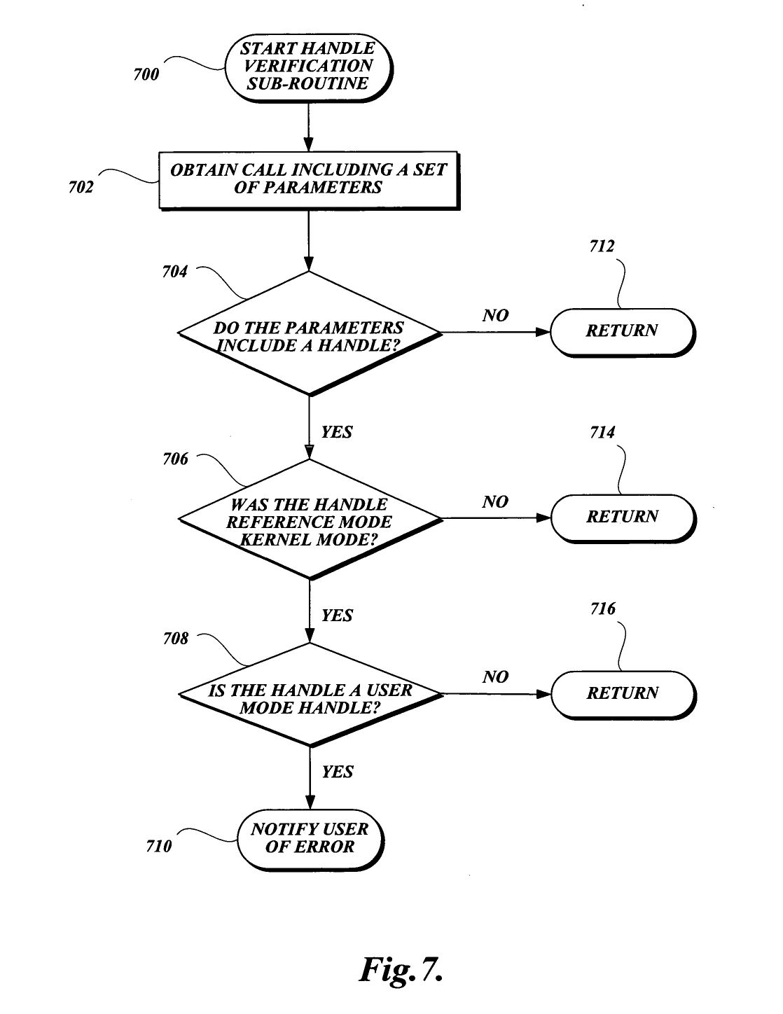

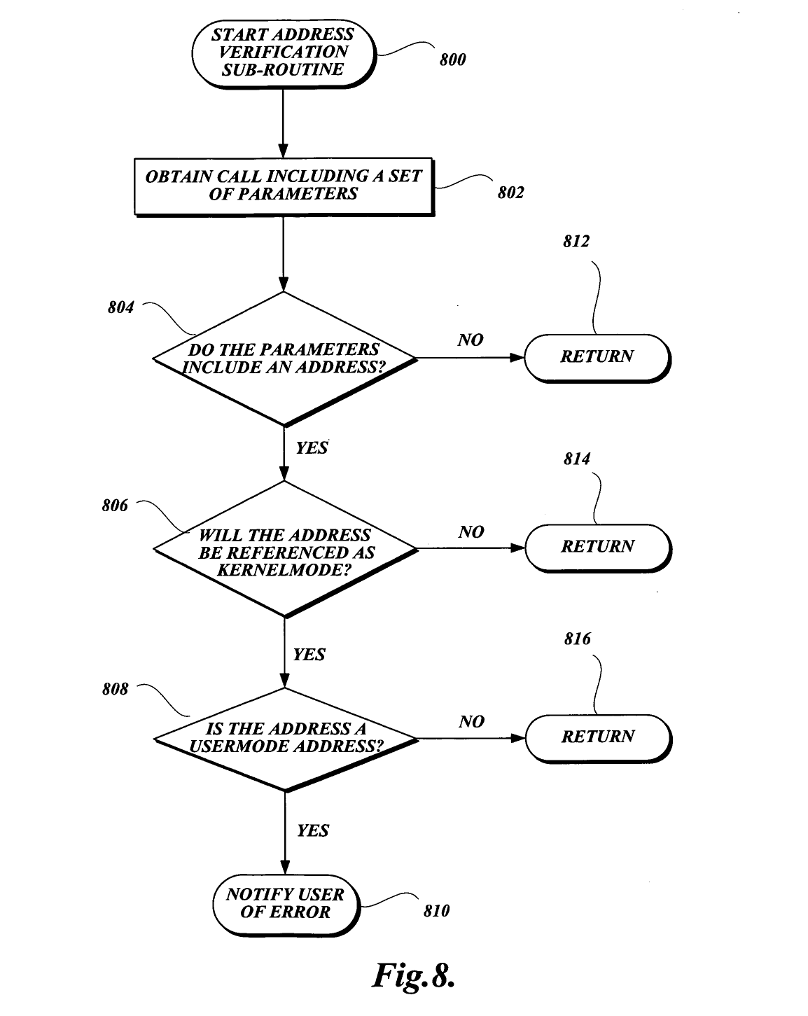

At block 206, the driver verification component 106 performs a handle verification sub-routine. In an illustrative embodiment, a request made to a driver component 104 may include a handle parameter. Further, in an illustrative embodiment the driver verification component 106 verifies that the handle conforms with security requirements. An exemplary handle verification sub-routine is depicted in FIG. 7 and will be described in greater detail below. At block 208, the driver verification component 106 performs an address verification sub-routine. A request made to a driver component 104 may include parameters which include an address. Accordingly, the driver verification component 106 can verify that the address conforms with security requirements. An exemplary address verification sub-routine is depicted in FIG. 8 and will be described in greater detail below. As will be appreciated by those skilled in the art, requests transmitted to driver components 104 may be in the form of calls from another software component in the computer system 100. At block 210, routine 200 terminates. In an illustrative embodiment, the driver verification component 106 can perform any one or more of the sub-routines referenced in FIG. 2.

With reference now to FIG. 3, an exemplary hang-verification sub-routine 300 implemented by a verifier component 106 will be described. Beginning at block 302, the driver verification component 106 obtains an I/O request, such as in the form of an I/O request packet. In an illustrative embodiment, a user may determine which I/O requests are monitored by the driver verification component 106, such as by selecting I/O requests based on characteristics of the request. For example, I/O requests that originated from a user mode application may be monitored. In another illustrative embodiment, I/O requests may be monitored based on computer system 100 settings or monitored based on the driver which transmitted the request. In a further embodiment, an I/O request may include information that is to be written to disk or may include instructions for controlling a device.

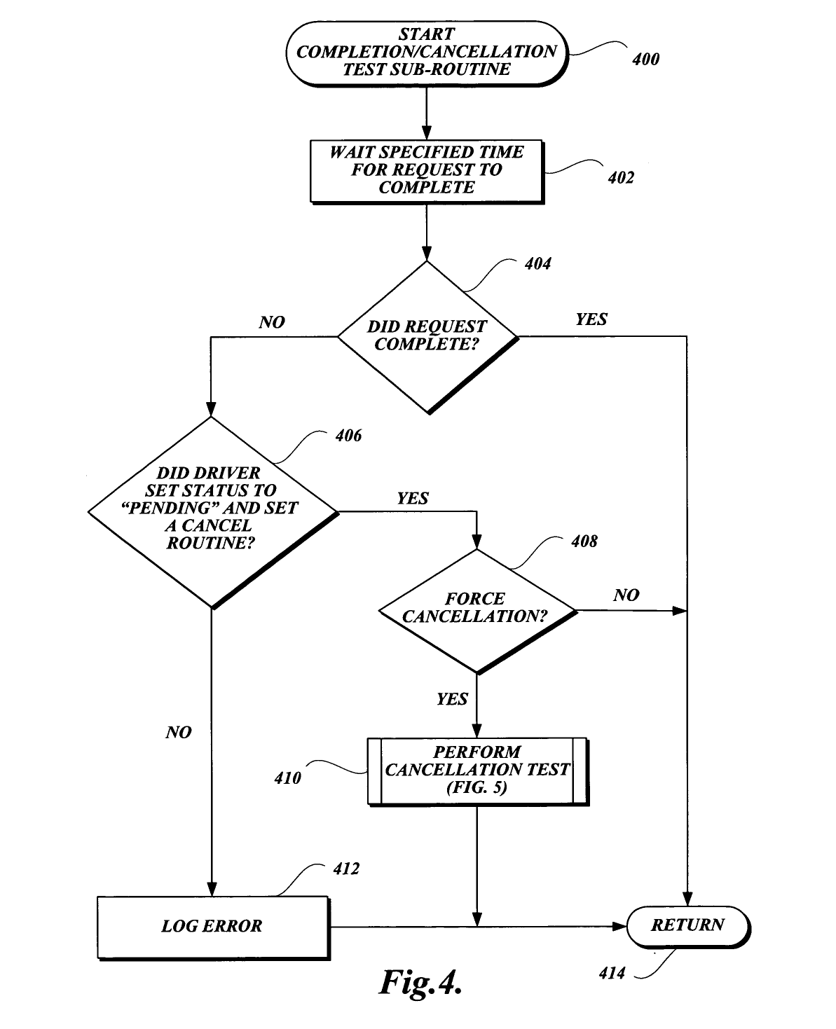

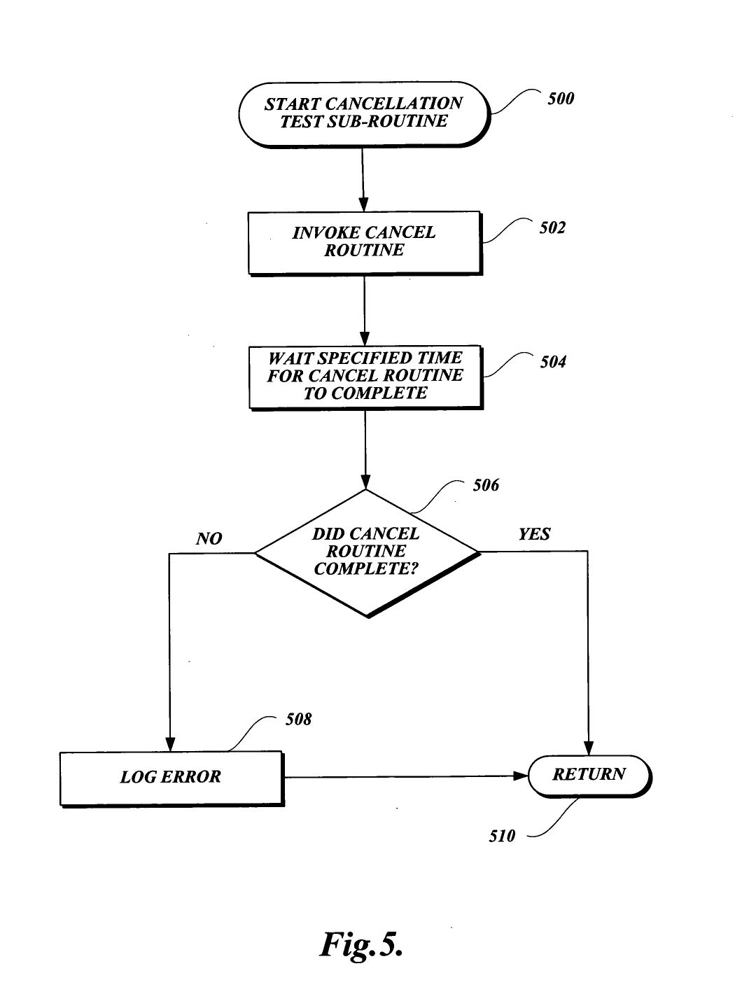

At decision block 304, a test is conducted to determine if execution of a cancellation test is requested. In an illustrative embodiment, a user or administrator can issue a request that results in execution of a cancellation test. If cancellation was requested, a cancellation test is executed at block 306. An exemplary cancellation test is depicted in FIG. 5 and will be described in greater detail below. If cancellation was not requested, then a completion test, and possibly a cancellation test, is executed at block 308. An exemplary completion/cancellation test is depicted in FIG. 4 and will be described in greater detail below. At block 310, sub-routine 300 returns to routine 200.

With reference now to FIG. 4, an exemplary completion, with possible forced cancellation, test sub-routine 400 will be described. Beginning at block 402, the sub-routine waits a specified period of time for an I/O request that has been submitted for completion to complete. In an illustrative embodiment, I/O requests are submitted for completion after a driver component 104 has finished processing the request. At decision block 404, a test is conducted to determine if the request completed. If the request did not complete, at decision block 406, a test is conducted to determine whether a driver component 104 returned “pending” status and set a cancel routine. In an illustrative embodiment, the test conducted at decision block 406 ensures that driver components 104 pend requests that exceed the specified completion time and associate the requests with a cancel routine. As will be appreciated by one skilled in the art, a cancel routine associated with a request can be executed if a thread that issued the request exits before the request is completed. If an I/O request is not pended, an error is logged at block 412. If a cancel routine was not set, an error is logged at block 412.

If a driver component 104 pended the request and set a cancel routine, a test is conducted at decision block 408 to determine whether cancellation should be forcibly injected. In an illustrative embodiment, a probability parameter can be used to determine whether cancellation should be forcibly injected. For example, a user may configure the probability parameter such that cancellation is forcibly injected a certain percentage of time. In an illustrative embodiment, the probability parameter allows a user to inject forced cancellations into a specified percentage of requests. If, at decision block 408, it is determined that cancellation should be forcibly injected, then a cancellation test is executed at block 410. An exemplary cancellation test is depicted in FIG. 5 and will be described in greater detail below. At block 414, sub-routine 400 returns to sub-routine 300.

With reference now to FIG. 5, an exemplary cancellation test sub-routine 500 implemented by a driver verification component 106 will be described. Beginning At block 502, a cancel routine associated with a request is invoked. At block 504, the driver verification component 106 waits a specified period of time for the cancel routine to complete. In an illustrative embodiment, a cancel routine associated with a request is responsible for releasing resources acquired during processing of a request and completing the request with a canceled status. At block 506, a test is conducted to determine whether the cancel routine completed. An error is logged at block 508 if a cancel routine associated with a request failed to complete within the specified time. At block 510, sub-routine 500 returns. In an illustrative embodiment, sub-routine 500 returns to sub-routine 400. In another embodiment, sub-routine 500 returns to sub-routine 300.

With reference now to FIG. 6, an exemplary pending verification sub-routine 600 will be described. In an illustrative embodiment, the pending verification sub-routine 600 allows a user to test driver component 104 behavior while a request is pending. For example, a first driver may transmit an I/O request to a second driver with the second driver returning a pending status to the first driver. In an illustrative embodiment, the pending verification sub-routine 600 allows a user to simulate this scenario. Beginning at block 602, the driver verification component 106 obtains an I/O request. At block 604, the status of the request is set based on the handling of the request. In an illustrative embodiment, the driver verification component 106 attempts to complete the request by transmitting the request to the kernel component 108. Further, in an illustrative embodiment, a status code returned from the kernel component 108 is used to set the request status.

At decision block 606, a test is conducted to determine whether the request is pending. In an illustrative embodiment, if the request is pending, then the portion of driver component code which handles pending requests can be exercised without any action on the part of the driver verification component 106. Thus, at block 608, sub-routine 600 returns to routine 200. If the request is not pending, a test is conducted at decision block 610 to determine whether the request status should be forced to pending. In an illustrative embodiment, forced pendings may be injected based on a probability -parameter. For example, a user may choose to inject forced pendings into a certain percentage of requests. In an illustrative embodiment, the driver verification component 106 determines whether status pending should be injected into a request by calculating a random number and comparing it with the probability parameter. If forced pending status is not injected into a request, at block 608, sub-routine 600 returns to routine 200.

In an illustrative embodiment, if pending status is to be forcibly injected, at block 612, the status of the request is saved. In an illustrative embodiment, the driver verification component 106 creates a data structure in which to store the request status. At block 614, the status of the request is set to “pending.” In an illustrative embodiment, setting the status of the request to pending allows a driver component 104 to exercise a portion of code which handles pending requests, which is depicted at block 616. The pending verification sub-routine 600 can be used to ensure that data structures associated with an I/O request are not freed until the request completes. At block 618, the request status stored at block 612 is restored and processing of the request is resumed. At block 620, sub-routine 600 returns to routine 200.

With reference now to FIG. 7, an exemplary handle verification sub-routine 700 will be described. Beginning at block 702, a call including a set of parameters is obtained. In an illustrative embodiment, the call is obtained from a driver component 104. At decision block 704, a test is conducted to determine whether the parameters include a handle. As will be appreciated by one skilled in the art, a handle can be an object identifier. If the parameters do not include a handle, at block 712, sub-routine 700 returns to routine 200. Alternatively, at decision block 706, a test is conducted to determine whether the handle reference mode is kernel mode. In an illustrative embodiment, handles can be referenced as either kernel mode or user mode.

If the handle is not referenced as kernel mode, at block 714, sub-routine 700 returns to routine 200. Otherwise, at decision block 708, a test is conducted to determine whether the handle is a user mode handle. In an illustrative embodiment, a handle may be either a user mode handle or a kernel mode handle. If the handle is not a user mode handle, at block 716, sub-routine 700 returns to routine 200. Alternatively, a user is notified of an error at termination block 710. Error notification may occur through initiation of a bug check, by logging the error, or through other techniques well-known in the art. Thus, sub-routine 700 results in an error notification when user mode handles are referenced as kernel mode. In an illustrative embodiment, a user can select to verify a subset of driver calls. Further, a subset of driver calls may be verified based on system settings.

With reference now to FIG. 8, an exemplary address verification sub-routine 800 will be described. Beginning at block 802, a call including a set of parameters is obtained. In an illustrative embodiment, the call is obtained from a driver component 104. At decision block 804, a test is conducted to determine whether the parameters include a memory address. As will be appreciated by one skilled in the art, an address can reference a segment of memory. If the parameters do not include an address, at block 812, sub-routine 800 returns to routine 200. Otherwise, at decision block 806, a test is conducted to determine whether the address will be referenced as kernel mode. In an illustrative embodiment, addresses can be referenced as either kernel mode or user mode.

If the address will not be referenced as kernel mode, at block 814, sub-routine 800 returns to routine 200. Otherwise, at decision block 808, a test is conducted to determine whether the address is a user mode address. In an illustrative embodiment, an address may be either a user mode address or a kernel mode address. If the address is not a user mode address, at block 816, sub-routine 800 returns to routine 200. Alternatively, a user is notified of an error at termination block 810. Error notification may occur through initiation of a bug check, by logging the error, or through other techniques well-known in the art. Thus, sub-routine 800 results in an error notification when user mode addresses will be referenced as kernel mode. In an illustrative embodiment, a user can select to verify a subset of driver calls. Further, a subset of driver calls may be verified based on system settings.

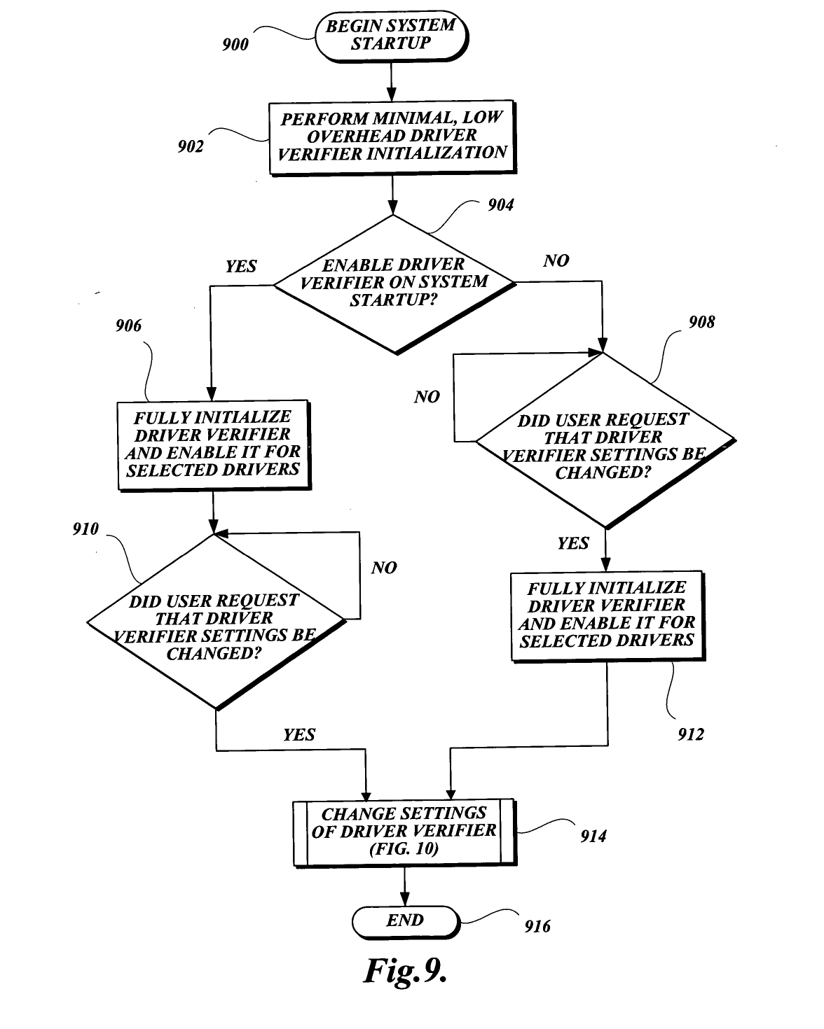

With reference now to FIG. 9, in an illustrative embodiment 900, the driver verification component 106 can be initialized in at least two stages. In an illustrative embodiment, at system startup, a first initialization 902 of the driver verification component 106 can be performed. Further, in an illustrative embodiment, the first initialization can be a minimal, low overhead initialization. In an illustrative embodiment, a first initialization can include initializing core data structures associated with the driver verification component 106. Further, in an illustrative embodiment, a first initialization can include discovering and storing the addresses of system application programming interfaces (APIs) that might be redirected to a driver verification method. Redirection of system APIs will be discussed in more detail below.

At decision block 904, a test is conducted to determine whether the driver verification component 106 should be fully enabled on system startup. In an illustrative embodiment, a system parameter may be set to signal that the driver verification component 106 is to be fully enabled on system startup. If the driver verification component 106 is to be fully enabled on system startup, at block 906, the driver verification component 106 is fully initialized and enabled for selected drivers. In an illustrative embodiment, a user selects the driver components 104 to be verified. Further, a full initialization can include adding driver component names to the list of drivers to be verified. Still further, a full initialization can include initializing a set of verification checks, initializing verifier sub-modules, and applying verifier hook functions to verified drivers.

At block 910, a test is conducted to determine whether a user requested changes to be made to driver verification component 106 settings. Changes to driver verification component settings can include a user request to add another driver to a verification list. Further, a user can request that a set of verification checks be changed. The driver verification component 106 waits until a user requests modifications before proceeding to block 914.

If the driver verification component 106 is not fully enabled on system startup at block 904, then, a test is conducted at decision block 908 to determine whether a user requested to make changes to driver verification component 106 settings. The test at decision block 908 is similar-to the test conducted at decision block 910 described above. In an illustrative embodiment, if a user did request changes, then the driver verification component is fully initialized and enabled for selected drivers at block 912. Further, the full initialization performed at block 912 is similar to the full initialization performed at block 906. Thus, if the driver verification component 106 is not fully initialized on system startup, then the driver verification component 106 can be fully initialized after a user requests that settings be changed. At block 914, the settings of the driver verification component can be modified.

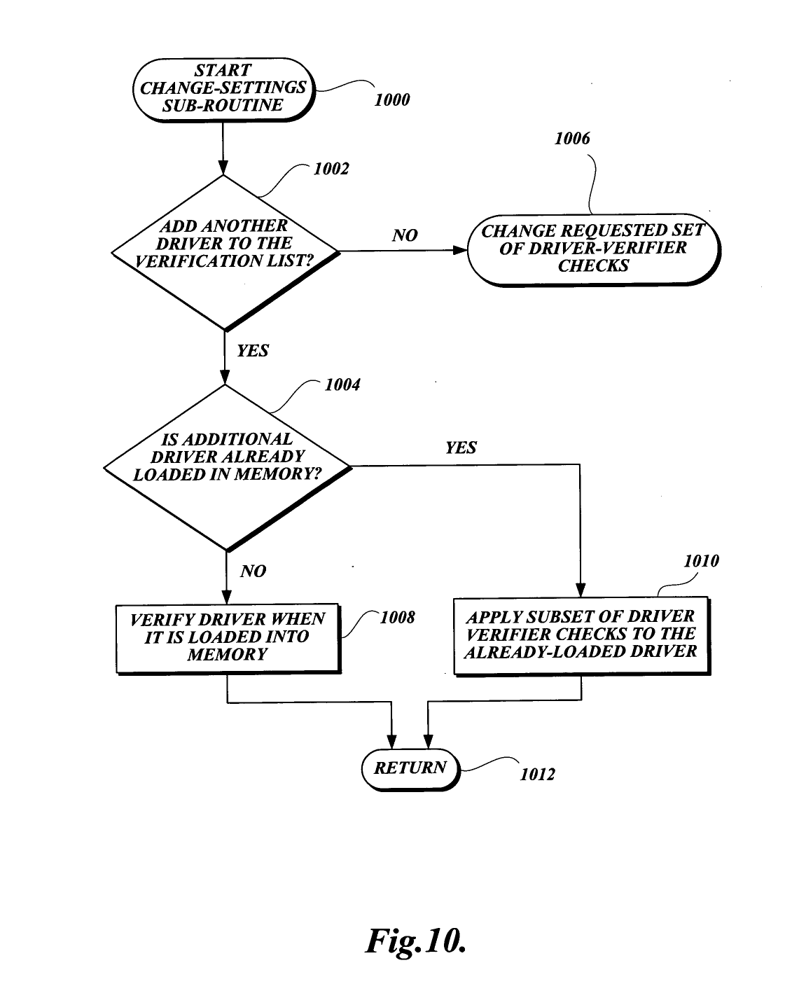

FIG. 10 depicts an exemplary sub-routine 1000 in which driver verification settings can be changed. Beginning at decision block 1002, a test is conducted to determine whether a user requested that a driver be added to a verification list. If a user did not request to add a driver to the verification list, then the requested set of driver verifier checks are changed at termination block 1006. For example, a user may choose to switch from performing fault injection tests to running a hang verification sub-routine. Further, each requested verification check can be applied. If a user has requested to add another driver to a verification list, then a test is conducted at decision block 1004 to determine if the requested driver is loaded in memory. If the driver is not loaded into memory, then, at block 1008, verification checks can be applied when the driver is loaded into memory. Alternatively, a subset of verification checks can be applied at block 1010. In an illustrative embodiment, applying a subset of checks to a loaded driver can be accomplished through API function hooking, which is described below. At block 1012, sub-routine 1000 returns to routine 900. At block 916, routine 900 terminates.

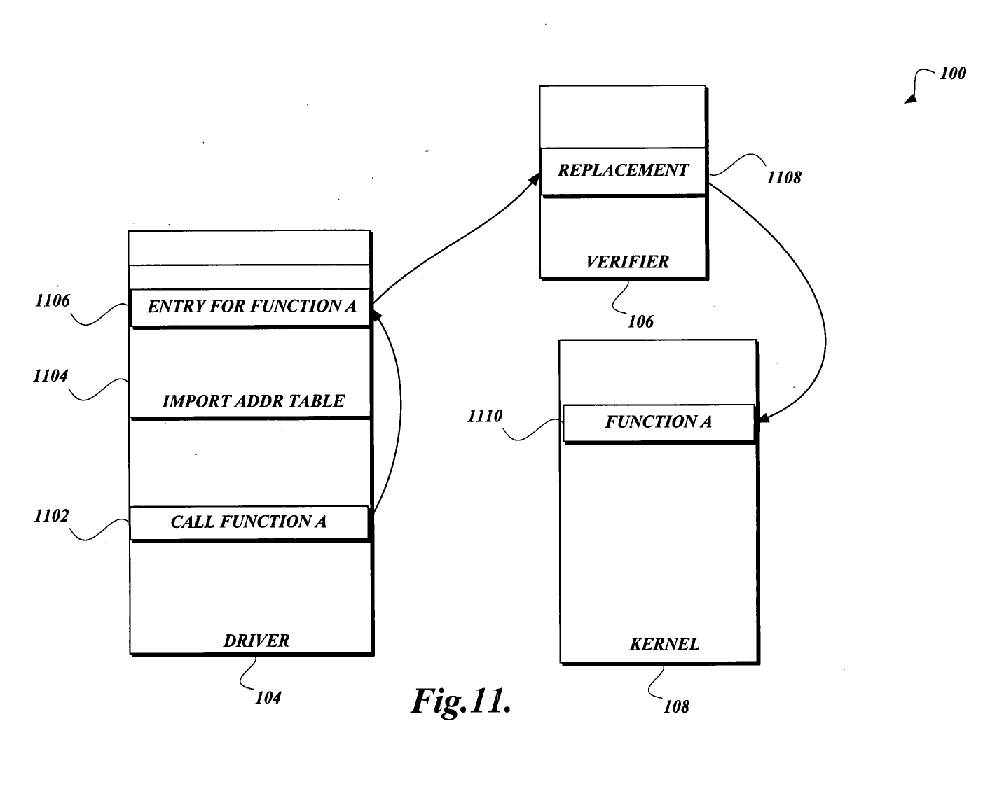

With reference now to FIG. 11, in an exemplary computer system 100 in which driver verification is performed, driver verification functions hook into driver component 104 function calls. In an illustrative embodiment, function hooking, also known as API hooking, may be performed by making direct modifications to the Import Address Tables (IAT) 1104 of the driver component 104. Generally described, each driver has its own IAT that contains the entry-point addresses of the kernel APIs that are used. Such entry point addresses can be used when the process makes a call to the corresponding APIs. Therefore, by replacing the entry-point address of an API (in the IAT) with that of a replacement function, it is possible to redirect any calls to the API to the verifier replacement function 1108. It is to be noted that IAT modification is described as an example. It is contemplated that any suitable API hooking method can be used to intercept API calls. In FIG. 11, the entry-point address of FUNCTION A 1106 in an IAT has been modified so that when the driver calls FUNCTIONA 1102, the replacement function 1108 associated with the driver verification component can be executed. After the replacement function 1108 processes the request, the replacement function calls the corresponding kernel FUNCTION A 1110.

In an illustrative embodiment, a request to verify a driver component may be obtained after a driver component has been loaded into memory. In such a case, a subset of requested verification checks can be implemented. Whether a replacement function is hooked into a driver can be based on dependencies that can exist between other replacement functions. For example, a replacement function can be hooked if the replacement function does not depend on data from other replacement functions.

In an illustrative embodiment, the driver verification component 106 can simulate a low resource environment. For example, the driver verification component 106 can simulate low memory conditions by failing some of the memory allocation requests made by a driver component 104. A user can specify a custom probability which controls the frequency of failed resource allocation requests. Additionally, the driver verification component 106 allows a user to select one or more user programs 102 for fault injection. For example, a driver component 104 may receive requests from User Program A and User Program B. If desired, the user can configure the driver verification component 106 such that faults will only be injected when the driver component 104 is in communication with User Program A.

In an illustrative embodiment, a user can specify a boot time grace period before which time the driver verification component 106 will not perform any verification checks. For example, a user can specify that verification checks should start no sooner than 2 minutes after the system 100 boots up. Additionally, a user can choose to verify selected code paths of the driver component 104. For example, memory used by a driver component 104 can be tagged with an identification value. In an illustrative embodiment, a user can select tag values to inject with faults.

While illustrative embodiments have been illustrated and described, it will be appreciated that various changes can be made therein without departing from the spirit and scope of the invention.

1. A method for verifying driver component behavior, the method comprising:
verifying that a driver component processes I/O requests in a specified amount of time;
verifying that pending I/O requests are processed correctly by a driver component; and
verifying that a set of parameters in a call to a driver component conforms with security requirements.

2. The method as recited in claim 1, wherein verifying that a driver component processes I/O requests in a specified amount of time includes:
obtaining an I/O request, wherein the I/O request is associated with a request status; and
executing a completion test.

3. The method as recited in claim 2, wherein executing a completion test includes:
waiting a specified amount of time and determining whether the I/O request completed; and
verifying that the driver component set the request status to pending and verifying that the driver component set a cancel routine if the I/O request is pending.

4. The method as recited in claim 1, wherein verifying that a driver component processes I/O requests in a specified amount of time includes:
obtaining an I/O request, wherein the I/O request is associated with a request status; and
executing a cancellation test.

5. The method as recited in claim 4, wherein executing a cancellation test includes:
executing a cancel routine; and
verifying that the cancel routine completes within a specified amount of time.

6. The method as recited in claim 1, wherein verifying that a driver component processes I/O requests in a specified amount of time includes:
obtaining an I/O request;
executing a cancellation test if a cancellation test is requested; and
executing a completion test if a cancellation test is not requested and executing a cancellation test if a force cancellation parameter is set.

7. The method as recited in claim 1, wherein verifying that pending I/O requests are processed correctly by a driver component includes:
obtaining an I/O request, wherein the I/O request is associated with a status;
saving the status of the I/O request in a data structure;
setting the status of the I/O request to pending;
testing a portion of a driver component which handles pending requests; and
restoring the status of the I/O request from the data structure.

8. The method as recited in claim 1, wherein verifying that a set of parameters in a call to a driver component conforms with security requirements includes:
obtaining a call including a set of parameters, wherein the set of parameters includes a handle, and wherein the handle is associated with a reference mode; and
notifying a user of an error condition if the handle reference mode is kernel mode and the handle is a user mode handle.

9. The method as recited in claim 1, wherein verifying that a set of parameters in a call to a driver component conforms with security requirements includes:
obtaining a call including a set of parameters, wherein the set of parameters includes an address; and
notifying a user of an error condition if the address will be referenced as kernel mode and the address is a user mode address.

10. A computer-readable medium having computer-executable modules for verifying driver components, the computer-executable modules, comprising:
a verification test module for determining whether a driver component processes I/O requests in a specified amount of time;
a verification test module for determining whether pending I/O requests are processed correctly by a driver component; and
a verification test module for determining whether a set of parameters in a call to a driver component conforms with security requirements.

11. The computer-readable medium having computer-executable modules as recited in claim 10, wherein determining whether a driver component processes I/O requests in a specified amount of time includes:
obtaining an I/O request, wherein the I/O request is associated with a request status; and
executing a completion test.

12. The computer-readable medium having computer-executable modules as recited in claim 11, wherein executing a completion test includes:
waiting a specified amount of time and determining whether the I/O request completed; and
verifying that the driver component set the request status to pending and verifying that the driver component set a cancel routine if the I/O request is pending.

13. The computer-readable medium having computer-executable modules as recited in claim 10, wherein determining whether a driver component processes I/O requests in a specified amount of time includes:
obtaining an I/O request, wherein the I/O request is associated with a request status; and
executing a cancellation test.

14. The computer-readable medium having computer-executable modules as recited in claim 13, wherein executing a cancellation test includes:
executing a cancel routine; and
verifying that the cancel routine completes within a specified amount of time.

15. The computer-readable medium having computer-executable modules as recited in claim 10, wherein determining whether pending I/O requests are processed correctly by a driver component includes:
obtaining an I/O request, wherein the I/O request is associated with a status;
saving the status of the I/O request in a data structure;
setting the status of the I/O request to pending;
testing a portion of a driver component which handles pending requests; and
restoring the status of the I/O request from the data structure.

16. The computer-readable medium having computer-executable modules as recited in claim 10, wherein determining whether a set of parameters in a call to a driver component conforms with security requirements includes:
obtaining a call including a set of parameters, wherein the set of parameters includes a handle, and wherein the handle is associated with a reference mode; and
notifying a user of an error condition if the handle reference mode is kernel mode and the handle is a user mode handle.

17. The computer-readable medium having computer-executable modules as recited in claim 10, wherein determining whether a set of parameters in a call to a driver component conforms with security requirements includes:
obtaining a call including a set of parameters, wherein the set of parameters includes an address; and
notifying a user of an error condition if the address will be referenced as kernel mode and the address is a user mode address.

18. A method for enabling a driver verification component, the method comprising:
performing a first initialization of the driver verification component, wherein the first initialization includes initializing data structures associated with the driver verification component;
obtaining a request to fully enable the driver verification component;
performing a second initialization of the driver verification component, wherein the second initialization fully enables the driver verification component for selected driver components; and
modifying settings associated with the driver verification component.

19. The method as recited in claim 18, wherein modifying settings associated with the driver verification component includes:
obtaining a request to add a driver component to a verification list; and
applying a subset of verification tests to the driver component if the driver component has been loaded into memory.

20. The method as recited in claim 18, wherein modifying settings associated with the driver verification component includes:
obtaining a request to modify a set of active verification tests; and
modifying the set of active verification tests.
